(19) United States
(12) Patent Application Publication
(10) Pub. No.: US 2008/0122645 A1
(43) Pub. Date: May 29, 2008

(54) Seat sensor

(75) Inventors: Yukihiro Saitoh, Chiryu-city (JP); Hiroyuki Itoh, Chita-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 11/985,309

(22) Filed: Nov. 14, 2007

(30) Foreign Application Priority Data
Nov. 29, 2006 (JP) 2006-321931

(51) Int. Cl. G08B 21/00

(52) U.S. Cl. 340/667

(57) ABSTRACT

A seat sensor for detecting that an occupant is seated on a vehicle seat having a back rest portion includes a sensor cell. The sensor cell is disposed on the back rest portion of the vehicle seat. The sensor cell has a plurality of electrodes that are arranged to face with each other. One of the plurality of electrodes contacts another one of the plurality of electrodes to make the sensor cell become conductive when the sensor cell is applied with a load.

### CROSS REFERENCE TO RELATED APPLICATION

This application is based on and incorporates herein by reference Japanese Patent Application No. 2006-321931 filed on Nov. 29, 2006

### BACKGROUND OF THE INVENTION

1. Field of the Invention

The present invention relates to a seat sensor that is used to detect that an occupant is seated with a vehicle seat. For example, present invention relates to a seat sensor that has a sensor cell that becomes conductive in accordance with a load of the occupant.

2. Description of Related Art

For example, JP-A-H10-39045 describes a seat sensor that is disposed to a seating surface portion of a vehicle seat, and the seat sensor is provided with multiple sensor cells all connected in parallel with each other. When one of the multiple sensor cells of the seat sensor is conducted, it is determined that an occupant is seated.

However, in the above case, for example, even when a baggage is place on the vehicle seat, any one of the sensor cells may become conductive. As a result, there is a possibility of an erroneous detection of the seating of the occupant.

JP-A-2005-153556 describes a seat sensor to address the above difficulty. The seat sensor is disposed to a seating surface portion of the vehicle seat, and is provided with two sensor cells that are connected in series with each other and disposed to a position of the seating surface portion toward a front side of the vehicle. The seat sensor is also provided with two other sensor cells that are connected in series and disposed to another position of the seating surface portion toward a rear side of the vehicle. The two sensor cells disposed on the front side of the seating surface portion are connected in parallel with the two other sensor cells disposed on the rear side of the seating surface portion. According to the above seat sensor, the detection of the seating of the occupant is made only when the two sensor cells in series that are disposed on at least one of the front side and the rear side become conductive simultaneously.

In general, baggage (e.g., handbag) placed on the vehicle seat has a very small mass compared with an occupant. Accordingly, if the baggage is placed on the seating surface portion of the vehicle seat to evenly apply a force thereto, the sensor cells have less possibility to become conductive. However, for example, when the baggage is placed on the seating surface portion in a slanted manner, the baggage may contact the seating surface portion on its corner, and thereby, a large load may be applied to a certain part of the seating surface portion. For example, a rear end part of the seating surface portion may be applied with a large load. In such a case, even the seat sensor described in JP-A-2005-153556 may erroneously detect the seating of the occupant, because the baggage may bring the two sensor cells in series on the rear end of the seating surface portion into conduction.

### SUMMARY OF THE INVENTION

The present invention is made in view of the above disadvantages. Thus, it is an objective of the present invention to address at least one of the above disadvantages.

To achieve the objective of the present invention, there is provided a seat sensor for detecting that an occupant is seated on a vehicle seat having a back rest portion, the seat sensor including a sensor cell. The sensor cell is disposed on the back rest portion of the vehicle seat. The sensor cell has a plurality of electrodes that are arranged to face with each other. One of the plurality of electrodes contacts another one of the plurality of electrodes to make the sensor cell become conductive when the sensor cell is applied with a load.

### BRIEF DESCRIPTION OF THE DRAWINGS

The invention, together with additional objectives, features and advantages thereof, will be best understood from the following description, the appended claims and the accompanying drawings in which:

FIG. 1 is a plan view of a seat sensor according to a first embodiment of the present invention;

FIG. 2 is an enlarged sectional view of a part of a sensor cell of the seat sensor;

FIG. 3 is a diagram of a configuration viewed from a front side of a vehicle in a state where the seat sensor is mounted on a vehicle seat;

FIGS. 4A and 4B are circuit diagrams of the seat sensor; and

FIG. 5 is a diagram of a configuration viewed from a frontward of the vehicle in a state where the seat sensor is mounted on a vehicle seat according to another embodiment of the present invention.

### DETAILED DESCRIPTION OF PREFERRED EMBODIMENTS

### First Embodiment

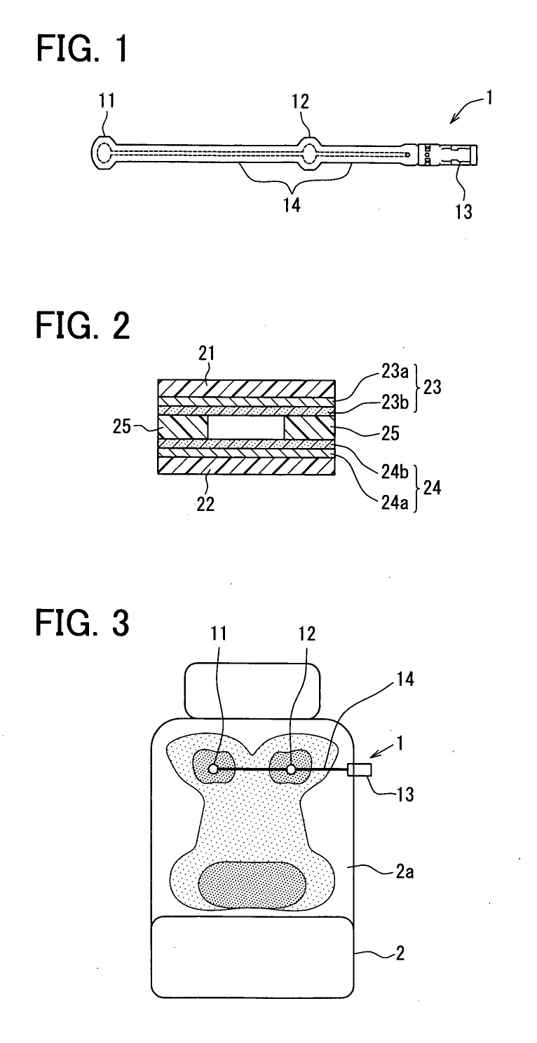

The first embodiment of the present invention is described referring to accompanying drawings of FIGS. 1 to 4.

As shown in FIG. 1, a seat sensor 1 includes two sensor cells 11, 12, a connector 13, and a conduction portion 14. The conduction portion 14 electrically 25 connects each of the sensor cell 11, 12 with the connector 13. Each of the sensor cells 11, 12 serves as a switch that becomes conductive when the sensor cell 11, 12 is applied with a load by an occupant or a baggage. The connector 13 has two terminals that are connected with the sensor cells 11, 12 via the conduction portion 14, and is connected with an occupant detection electronic control unit (ECU) mounted on a vehicle for detecting the occupant. Also, the conduction portion 14 is provided to extend in a straight manner from the connector 13. The sensor cell 11 and the sensor cell 12 are provided at an end portion and a central portion of the conduction portion 14 that extends straightly, respectively.

A sectional structure of the seat sensor 1 is specifically described referring to FIG. 2. As shown in FIG. 2, the seat sensor 1 has a first film 21, a second film 22, a first electrode 23, a second electrode 24, and a spacer 25. It is noted that in the seat sensor 1, the sensor cells 11, 12 and the conduction portion 14 are formed similarly to each other in the basic configuration, but specific configurations of the sensor cells 11, 12 and the conduction portion 14 are slightly different from each other. Thus, the difference between the configuration of the sensor cells 11, 12 and the configuration of the conduction portion 14 is clearly described.

The first film 21 serves as an outer edge of the sensor cells 11, 12 and the conduction portion 14, and is formed in a straight manner as a whole. The first film 21 is made of a PEN resin and has a thin shape. The first film 21 has generally circular shapes at the end portion and the central portion thereof. In other words, the first film 21 has generally the circular shapes at parts corresponding to the sensor cells 11, 12. The first film 21 has a straight shape at a part corresponding to the conduction portion 14. Here, the straight shape has a smaller width than a diameter of the circular shape. Also, the first film 21 has a base end portion that is connected with the connector 13. The second film 22 is made of the same material with the first film 21, and has the same shape with the first film 21. Also, the second film 22 is arranged to face the first film 21. The second film 22 has a base end portion that is connected with the connector 13 similar to the first film 21.

The first electrode 23 is provided on one side of the first film 21 (i.e., a lower side of the first film 21 in FIG. 2). In other words, the first electrode 23 is provided between the first film 21 and the second film 22 at a position closer to the first film 21 (e.g., upper side in FIG. 2). The first electrode 23 has a silver layer 23a and a carbon layer 23b. Here, the silver layer 23a is adhered to the one side of the first film 21, and the carbon layer 23b covers a surface of the silver layer 23a. Also, the first electrode 23 has parts corresponding to the sensor cells 11, 12, and the parts are formed at least on a central portion of the first film 21 that has a circular shape. Also, the first electrode 23 has another part that corresponds to the conduction portion 14, and the another part is provided and wired as necessary according to a circuit design.

The second electrode 24 is provide on one side of the second film 22, the one side facing the first electrode 23. For example, in FIG. 2, the second electrode 24 is provided on an upper side of the second film 22. In other words, the second electrode 24 is provided between the first film 21 and the second film 22 at a position closer to the second film 22 (i.e., at a lower position in FIG. 2). The second electrode 24 has a silver layer 24a and a carbon layer 24b. Here, the silver layer 24a is adhered to the side of the second film 22, and the carbon layer 24b covers the silver layer 24a. Furthermore, the carbon layer 24b of the second electrode 24 is spaced away from the first electrode 23. The second electrode 24 has parts that corresponds to the sensor cells 11, 12, and the parts are formed at least on a central portion of the second film 22 that has a circular shape. In other words, the first electrode 23 is arranged to face the second electrode 24 at the parts corresponding to the sensor cells 11, 12. Also, the second electrode 24 has another part that corresponds to the conduction portion 14, and the another part is provided and wired as necessary in accordance with the circuit design. In other words, the parts of the first electrode 23 and the second electrode 24 corresponding to the conduction portion 14 provide electrical communication between (a) the parts of the first electrode 23 and the second electrode 24 corresponding to the sensor cells 11, 12 and (b) the two terminals of the connector 13.

The spacer 25 has an outer edge shape that is similar to the outer edges of the first film 21 and the second film 22. However, the spacer 25 has a passage that extends through an entire of the spacer 25 at a central portion of the spacer 25 in a width direction as shown by a dashed line in FIG. 1. Typically, the width of the passage of the spacer 25 at each of the sensor cells 11, 12 is wider than the width of the passage at the conduction portion 14. The spacer 25 is made of a PET resin and has a thin shape.

The spacer 25 is provided between the first electrode 23 and the second electrode 24. In other words, in FIG. 2, a space is defined by the first electrode 23, the second electrode 24, and the spacer 25. Here, as described above, because the width of the passage of the spacer 25 at each of the sensor cells 11, 12 is wider than the width of the passage at the conduction portion 14, the width (a length in a transverse direction of FIG. 2) of the space at each of the sensor cells 11, 12 is wider than the width of the space at the conduction portion 14. As a result, when the wider space formed at each of the sensor cells 11, 12, is applied with a compression force in a vertical direction in FIG. 2 (e.g., a direction perpendicular to the first film 21), the first film 21, the second film 22, the first electrode 23, and the second electrode 24 are deformed flexibly. As a result, the first electrode 23 contacts the second electrode 24 such that the electrodes 23, 24 are electrically connected with each other. In other words, when each of the sensor cells 11, 12 is applied with a compression force, the first electrode 23 is electrically connected with the second electrode 24 to make each of the sensor cells 11, 12 become conductive. Thus, the sensor cells 11, 12 serve as switches. It is noted that the space formed at the conduction portion 14 serves as a passage that drains air. In other words, the space formed at the conduction portion 14 is configured to let internal air out when the space formed at each of the sensor cells 11, 12 is compressed.

Next, a condition where the seat sensor 1 is mounted on a vehicle seat 2 is described referring to FIG. 3. Here, shaded part in FIG. 3 indicates an area on a back rest portion 2a that receives the load when an occupant is seated on the vehicle seat 2. Specifically, a lower darker portion in the shaded part located close to the seating surface portion (toward the bottom of the back rest portion 2a in FIG. 3) corresponds to a hip (e.g. a waist) of the occupant, and two upper darker portions in the shaded part located toward a head rest (toward the top of the back rest portion 2a in FIG. 3) correspond to scapulas of the occupant. The upper and lower darker portions indicates the areas in the back rest portion 2a that receive a larger load than a lighter portion in the shaded part in FIG. 3 that corresponds to other part of a back of the occupant.

In general, a human back has a hip and scapulas that project from the back. Therefore, the back rest portion 2a of the vehicle seat 2 receives a large load by the hip and the scapulas of the occupant. Thus, the sensor cells 11, 12 of the present embodiment are provided to receive the load by the scapulas of the occupant that is seated on the vehicle seat 2. However, the seating height of human varies with people. Specifically, the seating height of an adult is significantly different from that of a child. It is noted that the child of a short seating height is, in general, obliged to be seated on a child seat or a junior seat. Accordingly, the target occupant that is a target of detection by the seat sensors of the present embodiment may be substantially an adult or a child having a height equivalent to that of the adult, for example. In other words, the scapula of the above target occupant is located at the upper side of the central portion of the back rest portion 2a in the vertical direction of the vehicle. As a result, the sensor cells 11, 12 can be provided at positions that receives the load by the scapulas of the occupant such that the sensor cells 11, 12 can receive sufficiently large load. In other words, the seat sensor 1 of the present embodiment can detect that the occupant is seated on the vehicle seat 2.

As shown in FIG. 3, the seat sensor 1 is mounted on the back rest portion 2a of the vehicle seat 2. Specifically, the seat sensor 1 is provided between a cushion and an outer shell of the back rest portion 2a. More specifically, in the seat sensor 1, each of the sensor cells 11, 12 is provided on an upper side of a vertically central portion of the back rest portion 2a. Here, the vertically central portion is located on a center of the back rest portion 2a in a vertical direction of the vehicle. Also, the sensor cells 11, 12 are respectively located on a right side and a left side of a transversely central portion of the back rest portion 2a. Here, the transversely central portion is located on a center of the back rest portion 2a in a transverse direction of the vehicle. Furthermore, the sensor cells 11, 12 are positioned at the same level in height with each other. In other words, the seat sensor 1 is arranged to extend horizontally.

More specifically, the sensor cells 11, 12 of the seat sensor 1 are located at positions that correspond to the right and left scapulas of the occupant in a state where the occupant is seated on the vehicle seat 2 with an appropriate posture. Therefore, when the occupant is seated on the vehicle seat 2 with an appropriate posture, each of the sensor cells 11, 12 is conducted. Also, the connector 13 is located on a side of the sensor cells 11, 12 toward a left side of the vehicle.

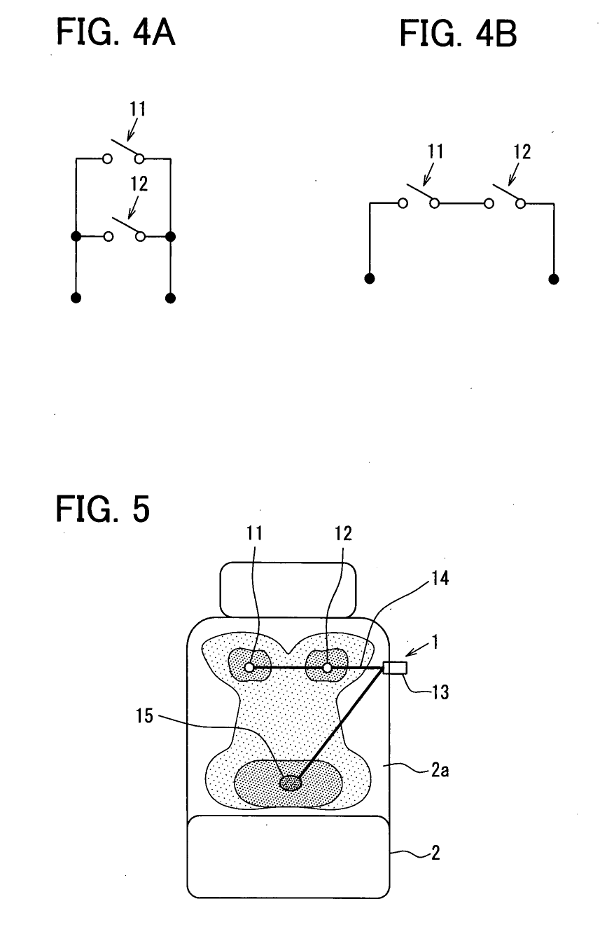

Next, a circuit configuration of the seat sensor 1 is described referring to FIGS. 4A and 4B. The circuit configuration of the seat sensor 1 is selected from circuit configurations shown in FIGS. 4A and 4B. In a case of the circuit configuration of FIG. 4A, the sensor cell 11 at the end of the conduction portion 14 is connected in parallel with the sensor cell 12 at the central portion of the conduction portion 14. Specifically, one of the first electrode 23 and the second electrode 24 at the sensor cell 11 and one of the first electrode 23 and the second electrode 24 at the sensor cell 12 are connected with one of the two terminals of the connector 13. Also, another one of the first electrode 23 and the second electrode 24 at the sensor cell 11 and another one of the first electrode 23 and the second electrode 24 at the sensor cell 12 are connected with another one of the two terminals of the connector 13. In other words, when at least one of the sensor cells 11, 12 becomes conductive, the two terminals of the connector 13 are electrically connected with each other.

Also, in a case of the circuit configuration of FIG. 4B, the sensor cell 11 at the end of the conduction portion 14 is connected in series with the sensor cell 12 at the central portion of the conduction portion 14. Specifically, one of the first electrode 23 and the second electrode 24 at the sensor cell 11 is directly connected in series with one of the first electrode 23 and the second electrode 24 at the sensor cell 12. Also, another one of the first electrode 23 and the second electrode 24 at the sensor cell 11 and another one of the first electrode 23 and the second electrode 24 at the sensor cell 12 are connected with the two terminals of the connector 13, respectively. In other words, only when each of the sensor cells 11, 12 becomes conductive simultaneously, the two terminals of the connector 13 are electrically connected with each other.

Next, advantages of the seat sensor 1 are described. When the occupant is seated on the vehicle seat 2 with an appropriate posture, the scapulas of the occupant presses both the sensor cells 11, 12 of the seat sensor 1. Therefore, in this case, each of the sensor cells 11, 12 becomes conductive, and the two terminals of the connector 13 are conducted with each other. In other words, the occupant detection ECU, which is connected with the connector 13, detects that the two terminals of the connector 13 are electrically connected with each other, and thereby determines that the occupant is seated on the vehicle seat 2.

Also, as shown in FIG. 4A, in a case where the seat sensor 1 is formed with the parallel circuit, even when the occupant is not seated with the appropriate posture, at least one of the sensor cell 11 and the sensor cell 12 can become conductive. Therefore, in the above case, it is also determined that the occupant is seated on the vehicle seat 2.

Here, the occupant detection ECU, for example, turns on or flickers a warning lamp when the occupant is seated on the vehicle seat 2 but does not wear a seatbelt. Also, occupant detection information detected by the occupant detection ECU is transmitted to an air bag ECU that controls a start of an occupant protection device, such as an air bag. Accordingly, the air bag ECU starts the occupant protection device when the vehicle collides with an exterior object if it is determined that the occupant is seated on the vehicle seat 2.

Also, a case where baggage is placed on the vehicle seat 2 is discussed. As described above, the two terminals of the connector 13 of the seat sensor 1 are electrically connected with each other when at least one of the sensor cell 11 and the sensor cell 12 becomes conductive (see FIG. 4A), or when each of the sensor cells 11, 12 becomes conductive simultaneously (see FIG. 4B).

Here, an example of the baggage placed on the vehicle seat 2 is described. A case where the baggage (e.g., a handbag) is placed on the seating surface portion of the vehicle seat 2 is considered. As long as the baggage leans on the back rest portion 2a, the baggage will not press the sensor cells 11, 12. Therefore, in the present case, the occupant detection ECU naturally determines that the occupant is not seated on the vehicle seat 2.

Next, for example, a case where the baggage leans on the back rest portion is discussed. In the present case, when the baggage is short in height (height), the baggage will not press the sensor cells 11, 12 that are located on the upper side of the central portion in the back rest portion 2a, the upper side being in the vertical direction of the vehicle. Accordingly, also in the present case, the occupant detection ECU determines that the occupant is not seated on the vehicle seat 2.

Here, when the baggage is long in height, the baggage may press the sensor cells 11, 12. However, the long baggage is, in general, accommodated in a luggage boot of the vehicle, or placed on a floor of a vehicle cabin. Consequently, a baggage placed on the vehicle seat 2 is, in practice, limited to the short baggage.

As a result, the erroneous detection due to the baggage can be reliably limited. It is noted that in a case of the circuit configuration where the sensor cells 11, 12 are connected in series with each other as shown in FIG. 4B, each of the sensor cells 11, 12 needs to be conductive for detection of the seating. In general, each of the sensor cells 11, 12 has less possibility to become conductive simultaneously by the baggage. Thus, the erroneous detection due to the baggage is certainly limited.

### Other Embodiment

In the above first embodiment, the seat sensor 1 includes the two sensor cells 11, 12. However, the configuration of the seat sensor is not limited to the above. For example, the seat sensor 1 may alternatively have only one sensor cell, or have three or more sensor cells. When the alternative seat sensor has the only one sensor cell, the sensor cell may be provided on one of a left side and right side in the back rest portion 2a in a transverse direction of the vehicle. Also, when another alternative seat sensor has three or more sensor cells, all of the sensor cells may be connected in series with each other. Alternatively, all of the sensor cells may be connected in parallel with each other. Also, part of the sensor cells may be connected in parallel with each other, and are connected in series with the rest of the sensor cells. Also, when the seat sensor has three or more sensor cells, the sensor cells may be displaced from each other in the vertical direction of the vehicle.

Also, the two sensor cells 11, 12 are not limited to be horizontally arranged. However, the sensor cells 11, 12 may be arranged to be slightly angled relative to a horizontal direction. When the sensor cells 11, 12 are slightly angled as above, the slightly angled sensor cells 11, 12 can more easily correspond to the variations of seating heights of the occupant. In other words, even when the occupants of various seating heights are seated on the vehicle seat 2, it is reliably detected that the occupants are seated.

When the seat sensor 1 includes three cells, the two sensor cells 11, 12 are located in the upper side of the back rest portion 2a as in the above first embodiment. Another one sensor cell 15 may be located at the bottom of the back rest portion 2a around the lower darker portion of the shaded part as shown in FIG. 5. Thus, the sensor cell 15 can detect the load applied by the hip of the occupant. The sensor cells 11, 12, 15 may be connected in various manners with each other. At least two of the sensor cells 11, 12, 15 may be connected in series with each other. Also, at least two of the sensor cells 11, 12, 15 may be alternatively connected in parallel with each other. In the present embodiment, the seating of the occupant is more accurately detected.

Additional advantages and modifications will readily occur to those skilled in the art. The invention in its broader terms is therefore not limited to the specific details, representative apparatus, and illustrative examples shown and described.

What is claimed is:

1. A seat sensor for detecting that an occupant is seated on a vehicle seat having a back rest portion, the seat sensor comprising:
a sensor cell that is disposed on the back rest portion of the vehicle seat, wherein:
the sensor cell has a plurality of electrodes that are arranged to face with each other; and
one of the plurality of electrodes contacts another one of the plurality of electrodes to make the sensor cell become conductive when the sensor cell is applied with a load.

2. The seat sensor according to claim 1, wherein:
the sensor cell is disposed on an upper side of a vertically central portion of the back rest portion in a vertical direction of the vehicle.

3. The seat sensor according to claim 2, wherein:
the sensor cell is one of a plurality of sensor cells;
a first one of the plurality of sensor cells is located on a first side of a transversely central portion of the back rest portion in a transverse direction of the vehicle; and
a second one of the plurality of sensor cells is located on a second side of the transversely central portion of the back rest portion opposite the first side in the transverse direction of the vehicle.

4. The seat sensor according to claim 3, wherein the first one of the plurality of sensor cells is connected in parallel with the second one of the plurality of sensor cells.

5. The seat sensor according to claim 3, wherein the first one of the plurality of sensor cells is connected in series with the second one of the plurality of sensor cells.

6. The seat sensor according to claim 2, wherein the sensor cell is applied with the load by a scapula of the occupant that is seated on the vehicle seat.

7. The seat sensor according to claim 3, wherein:
a third one of the plurality of sensor cells is disposed on a lower side of the vertically central portion of the back rest portion in the vertical direction of the vehicle.

8. The seat sensor according to claim 7, wherein:
the third one of the plurality of sensor cells is applied with the load by a hip of the occupant that is seated on the vehicle seat.

9. The seat sensor according to claim 1, wherein:
the sensor cell is one of a plurality of sensor cells; and
at least two of the plurality of sensor cells are connected in parallel with each other.

10. The seat sensor according to claim 1, wherein:
the sensor cell is one of a plurality of sensor cells; and
at least two of the plurality of sensor cells are connected in series with each other.
